(19) United States
(12) Patent Application Publication
(10) Pub. No.: US 2016/0063965 A1
(43) Pub. Date: Mar. 3, 2016

(54) METHOD OF DRIVING DISPLAY APPARATUS AND DISPLAY APPARATUS FOR PERFORMING THE SAME

(71) Applicant: Samsung Display Co., Ltd., Yongin-city (KR)

(72) Inventor: Dong-Gon YOO, Incheon (KR)

(21) Appl. No.: 14/663,045

(22) Filed: Mar. 19, 2015

(30) Foreign Application Priority Data
Aug. 26, 2014 (KR) 10-2014-0111707

(51) Int. Cl. G09G 5/391; G09G 3/34; G06T 7/20; G09G 5/30

(52) U.S. Cl. CPC G09G 5/391; G09G 5/30; G09G 3/346; G06T 7/204; G09G 2320/066; G09G 2320/0666; G09G 2340/0407; G09G 2320/0646

(57) ABSTRACT

A method of driving a display apparatus, the method including; measuring a distance between a viewer and the display apparatus, and adjusting a frame rate of an image displayed on a display panel based on the distance, wherein the display apparatus includes the display panel.

### CROSS-REFERENCE TO RELATED APPLICATION

This application claims priority from and the benefit of Korean Patent Application No. 10-2014-0111707, filed on Aug. 26, 2014, which is hereby incorporated by reference for all purposes as if fully set forth herein.

### BACKGROUND

1. Field

Exemplary embodiments of the present inventive concept relate to a display device, and more particularly to a method of driving a display apparatus and the display apparatus for performing the method.

2. Discussion of the Background

Generally, a display apparatus operates based on a fixed frame rate. As the frame rate is increased, a display quality increases, but a power consumption may also increase. As the frame rate is decreased, the power consumption decreases, but an afterimage and color breakup may also occur.

The afterimage and the color breakup recognized by a viewer vary with a viewing distance. The viewer recognizes the afterimage and the color breakup more from a closer viewing distance. The viewer recognizes the afterimage and the color breakup less from a farther viewing distance.

In the conventional display apparatus operating based on the fixed frame rate, when the viewing distance is long, the power is unnecessarily consumed although the viewer does not recognize the afterimage and the color breakup. When the viewing distance is short, the viewer recognizes the afterimage and the color breakup.

The above information disclosed in this Background section is only for enhancement of understanding of the background of the invention and therefore it may contain information that does not form any part of the prior art nor what the prior art may suggest to a person of ordinary skill in the art

### SUMMARY

Exemplary embodiments of the present inventive concept provide a method of driving a display apparatus capable of reducing a power consumption and improving display quality.

Exemplary embodiments of the present inventive concept also provide the display apparatus performing the method of driving the display apparatus.

Additional features of the invention will be set forth in the description which follows, and in part will be apparent from the description, or may be learned by practice of the invention.

An exemplary embodiment of the present inventive concept provides a method of driving a display apparatus, the method including: measuring a distance between a viewer and the display apparatus, and adjusting a frame rate of an image displayed on a display panel is adjusted based on the distance, wherein the display apparatus includes the display panel.

An exemplary embodiment of the present inventive concept also provides a display apparatus including; a display panel configured to display an image, a distance measuring component configured to measure a distance between a viewer and the display apparatus, a timing controller configured to adjust a frame rate of the image based on the distance, and generate a first control signal, a second control signal, and a data signal based on the frame rate, a gate driver configured to output a gate signal based on the first control signal, and a data driver configured to output a data voltage based on the second control signal and the data signal.

According to the method of driving the display apparatus and the display apparatus for performing the method, by adjusting the frame rate based on the distance between the viewer and the display apparatus, a power consumption of the display apparatus can be reduced when the distance is long and a display quality can be improved when the distance is short.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a display apparatus according to exemplary embodiments.

FIG. 2 is a block diagram illustrating an exemplary embodiment of a timing controller illustrated in FIG. 1.

FIGS. 3A, 3B, and 3C are diagrams for describing an exemplary operation of the timing controller illustrated in FIG. 2 when a frame rate decreases.

FIGS. 4A, 4B, 4C, and 4D are diagrams illustrating an exemplary operation of the timing controller of FIG. 2 when the frame rate increases.

FIG. 5 is a block diagram illustrating a display apparatus according to exemplary embodiments.

FIG. 6 is a diagram illustrating an image when a frame rate increases in FIG. 5.

FIG. 7 is a block diagram illustrating a display apparatus according to exemplary embodiments.

FIG. 8 is a block diagram illustrating an exemplary embodiment of a timing controller illustrated in FIG. 7.

FIG. 9 is an exemplary look-up table stored in a frame rate determining part illustrated in FIG. 8.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

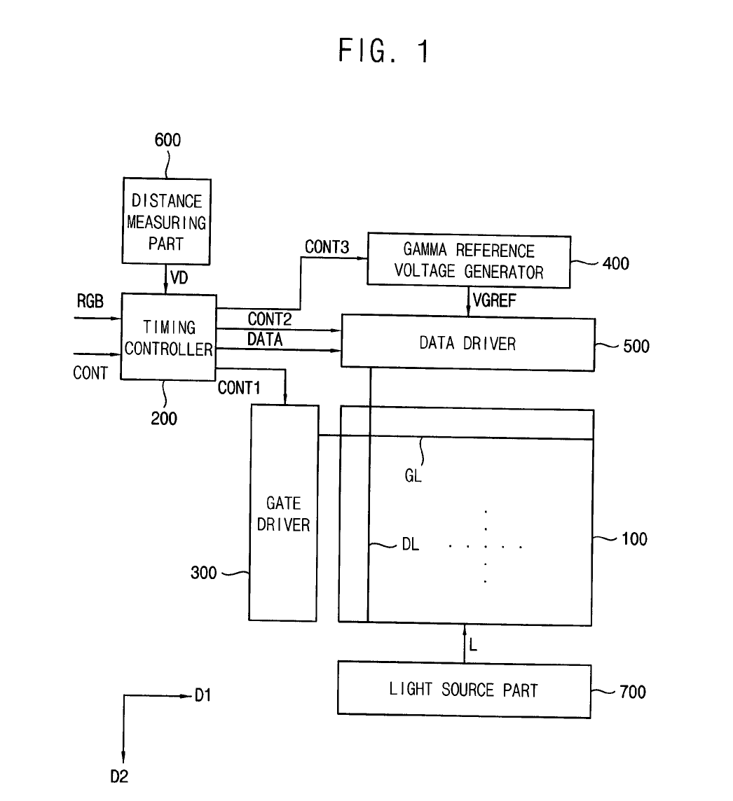

FIG. 1 is a block diagram illustrating a display apparatus according to exemplary embodiments.

Referring to FIG. 1, the display apparatus includes a display panel 100, a panel driver, a distance measuring part 600, and a light source part 700. The panel driver includes a timing controller 200, a gate driver 300, a gamma reference voltage generator 400 and a data driver 500.

The display panel 100 includes a display region for displaying an image and a peripheral region adjacent to the display region. The display panel 100 includes a plurality of gate lines GL, a plurality of data lines DL, and a plurality of pixels connected to the gate lines GL and the data lines DL. The gate lines GL extend in a first direction D1 and the data lines DL extend in a second direction D2 crossing the first direction D1.

The display panel 100 is configured to display the image. The image may include a first frame. The image may also include a second frame.

In an exemplary embodiment, each of the plurality of pixels may include a switching element (not shown), a liquid crystal capacitor (not shown) and a storage capacitor (not shown). The liquid crystal capacitor and the storage capacitor are electrically connected to the switching element. The plurality of pixels may be arranged in a matrix configuration.

The distance measuring part 600 measures a distance VD between a viewer and the display apparatus. The distance measuring part 600 may include a camera. The camera may be at least one of a stereo camera and a Time-of-Flight (ToF) camera, but not limited thereto. The distance measuring part 600 outputs the distance VD to the timing controller 200.

The timing controller 200 receives an input image data RGB and an input control signal CONT from an external device (not shown). The timing controller 200 receives the distance VD from the distance measuring part 600. The input image data RGB may include red image data R, green image data G and blue image data B. The input control signal CONT may include a master clock signal and a data enable signal. The input control signal CONT may further include a vertical synchronizing signal and a horizontal synchronizing signal.

The timing controller 200 is configured to generate a first control signal CONT1, a second control signal CONT2, a third control signal CONT3, a light source control signal CONT4, and a data signal DATA based on the input image data RGB, the input control signal CONT, and the distance VD.

The timing controller 200 is configured to generate the first control signal CONT1 for controlling an operations of the gate driver 300 based on the input control signal CONT and the distance VD, and output the first control signal CONT1 to the gate driver 300. The first control signal CONT1 may include a vertical start signal and a gate clock signal.

The timing controller 200 is configured to generate the second control signal CONT2 for controlling an operations of the data driver 500 based on the input control signal CONT and the distance VD, and output the second control signal CONT2 to the data driver 500. The second control signal CONT2 may include a horizontal start signal and a load signal.

The timing controller 200 is configured to generate the data signal DATA based on the input image data RGB and the distance VD, and output the data signal DATA to the data driver 500. For example, the timing controller 200 may adjust a frame rate of the image based on the distance VD.

The timing controller 200 is configured to generate the third control signal CONT3 for controlling an operations of the gamma reference voltage generator 400 based on the input control signal CONT and the distance VD, and output the third control signal CONT3 to the gamma reference voltage generator 400.

The timing controller 200 is configured to generate the light control signal CONT4 for controlling an operations of the light source part 700 based on the input control signal CONT and the distance VD, and output the light control signal CONT4 to the light source part 700.

The gate driver 300 is configured to generate gate signals for driving the gate lines GL in response to the first control signal CONT1 received from the timing controller 200. The gate driver 300 is configured to sequentially output the gate signals to the gate lines GL.

In an exemplary embodiment, the gate driver 300 may be directly mounted on the display panel 100, connected to the display panel 100 as a tape carrier package (TCP) type, or integrated on the peripheral region of the display panel 100.

The gamma reference voltage generator 400 is configured to generate a gamma reference voltage VGREF in response to the third control signal CONT3 received from the timing controller 200. The gamma reference voltage generator 400 is configured to output the gamma reference voltage VGREF to the data driver 500. The level of the gamma reference voltage VGREF corresponds to grayscales of a plurality of pixel data included in the data signal DATA.

In an exemplary embodiment, the gamma reference voltage generator may be disposed in one of the timing controller 200 or the data driver 500.

The data driver 500 is configured to receive the second control signal CONT2 and the data signal DATA from the timing controller 200, and receive the gamma reference voltage VGREF from the gamma reference voltage generator 400. The data driver 500 is configured to convert the data signal DATA to data voltages having analogue levels based on the gamma reference voltage VGREF. The data driver 500 is configured to output the data voltages to the data lines DL.

In an exemplary embodiment, the data driver 500 may be directly mounted on the display panel 100, connected to the display panel 100 as a tape carrier package (TCP) type, or integrated on the peripheral region of the display panel 100.

The light source part 700 is configured to receive the light control signal CONT4, and produce light L to the display panel 100.

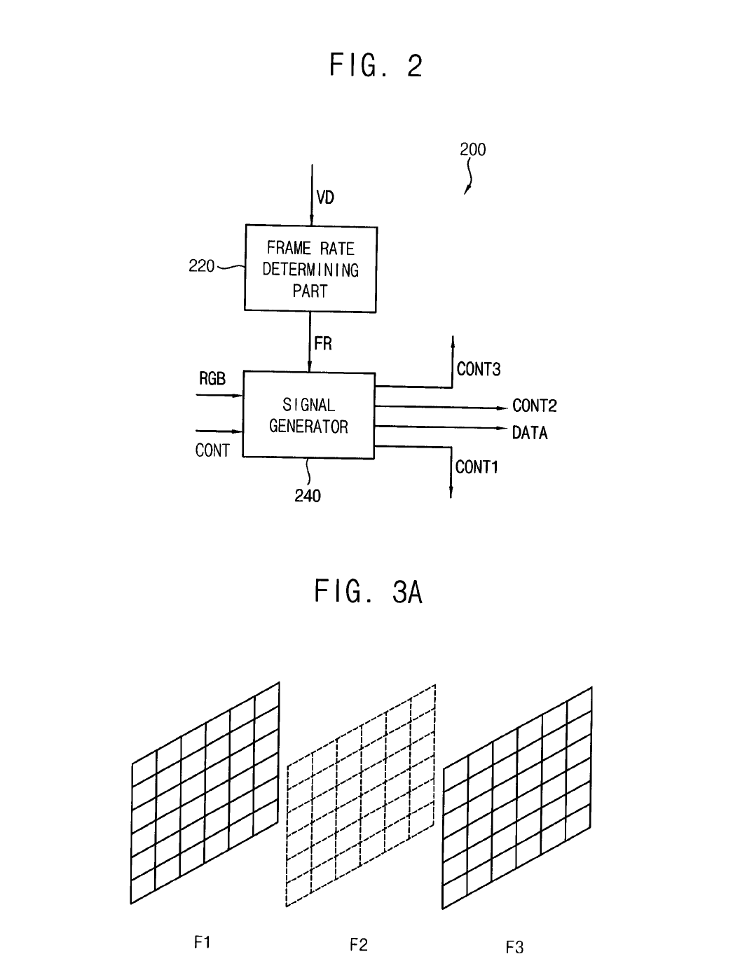

FIG. 2 is a block diagram illustrating an exemplary embodiment of a timing controller 200 illustrated in FIG. 1.

Referring to FIGS. 1 and 2, the distance measuring part 600 is configured to measure the distance VD between the viewer and the display apparatus. The distance VD may have a unit in meter and/or centimeter, but not limited thereto. The distance measuring part 600 may include the camera. The camera may be at least one of the stereo camera and the ToF camera, but not limited thereto. The distance measuring part 600 outputs the distance VD to the timing controller 200.

The timing controller 200 includes a frame rate determining part 220 and a signal generator 240. The frame rate determining part 220 receives the distance VD from the distance measuring part 600. The frame rate determining part 220 is configured to adjust the frame rate FR of the image displayed on the display panel 100 based on the distance VD. The frame rate determining part 220 may decrease the frame rate FR, as the distance VD become longer. The frame rate determining part 220 may increase the frame rate FR, as the distance VD become shorter.

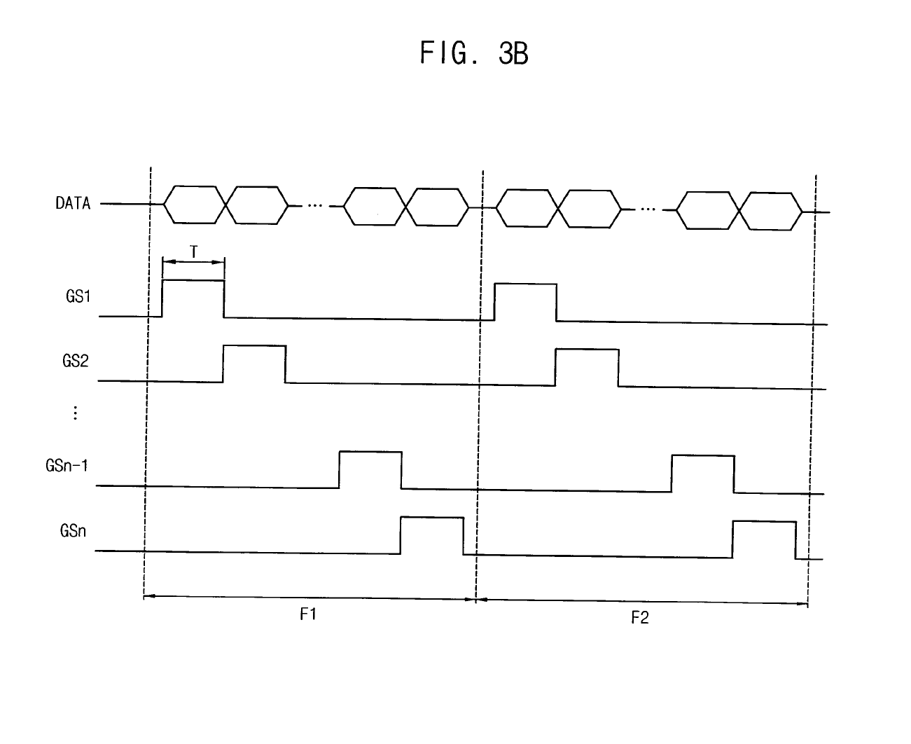

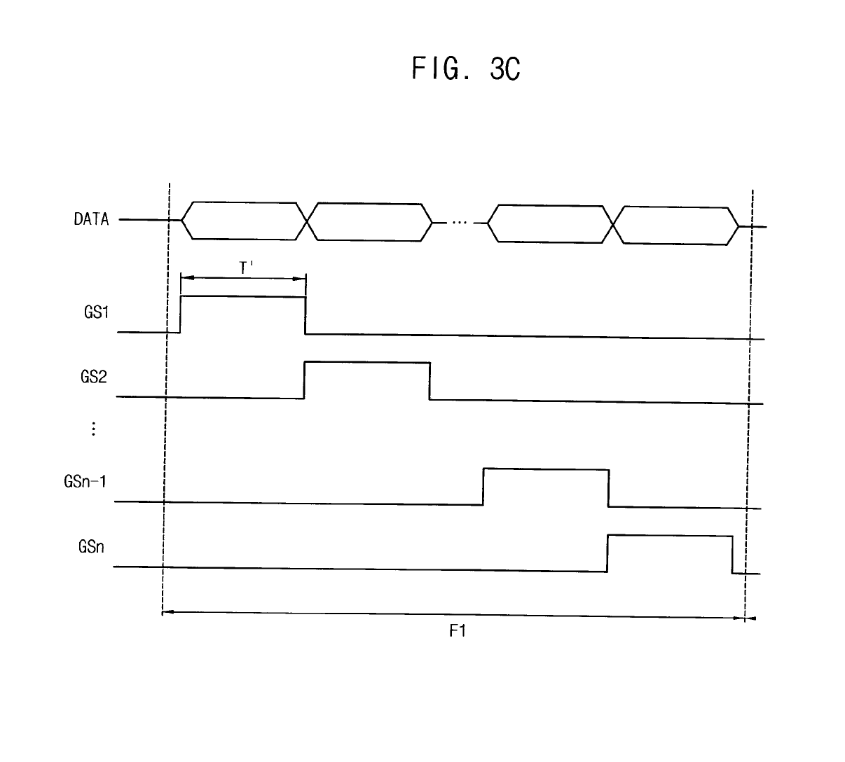

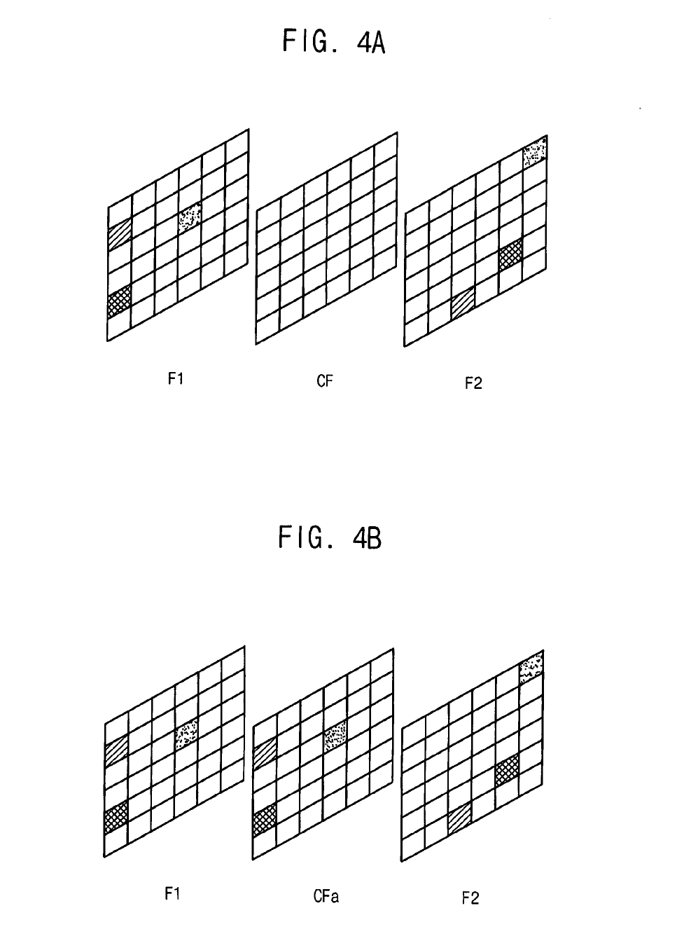

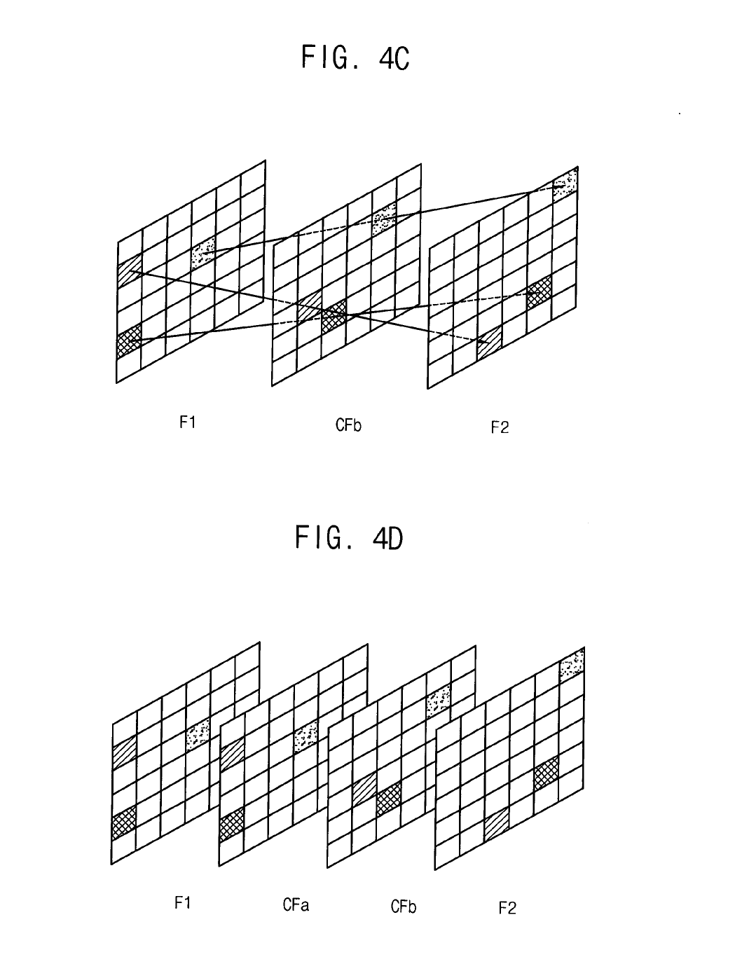

An exemplary operation of the frame rate determining part 220 will be described below with reference to FIGS. 3A, 4A, 4B, 4C, and 4D.

For example, the frame rate determining part 220 may adjust the frame rate FR based on a look-up table. The frame rate determining part 220 may also adjust the frame rate FR based on a predetermined function. An exemplary look-up table will be described below with reference to FIG. 9.

The signal generator 240 receives the frame rate FR from the frame rate determining part 220. The signal generator 240 receives the input image data RGB and the input control signal CONT from the external device (not shown).

The signal generator 240 outputs the first control signal CONT1 to the gate driver 300 based on the input control signal CONT and the frame rate FR. The first control signal CONT1 may control the operations of the gate driver 300 based on the frame rate FR. The first control signal CONT1 may include the vertical start signal and the gate clock signal.

The signal generator 240 is configured to output the second control signal CONT2 to the data driver 500 based on the input control signal CONT and the frame rate FR. The second control signal CONT2 may control the operations of the data driver 500 based on the frame rate FR. The second control signal CONT2 may include the horizontal start signal and the load signal.

The signal generator 240 is configured to output the data signal DATA to the data driver 500 based on the frame rate FR, the input image data RGB and the input control signal CONT. The data signal DATA may control the operations of the data driver 500 based on the frame rate FR.

The signal generator 240 is configured to output the third control signal CONT3 to the gamma voltage generator 400 based on the frame rate FR and the input control signal CONT.

The signal generator 240 is configured to output the light control signal CONT4 to the light source part 700 based on the frame rate FR and the input control signal CONT. The light control signal CONT4 may control the operations of the light source part 700 based on the frame rate FR.

A brightness of the light L of the light source part 700 may be decreased as the frame rate FR decreases. The brightness of the light L of the light source part 700 may be increased as the frame rate FR increases.

FIGS. 3A, 3B, and 3C are diagrams for describing an exemplary operation of the timing controller illustrated in FIG. 2 when a frame rate decreases.

FIG. 3A is an exemplary illustration of the image displayed based on the data signal DATA when the frame rate FR in FIG. 2 is decreased.

Referring to FIGS. 1, 2, and 3A, the distance measuring part 600 measures the distance VD between the viewer and the display apparatus. The distance measuring part 600 output the distance VD to the frame rate determining part 220.

The frame rate determining part 220 may adjust the frame rate FR of the image displayed on the display panel 100 based on the distance VD. The frame rate determining part 220 may decrease the frame rate FR, as the distance VD increases. The frame rate determining part 220 may increase the frame rate FR, as the distance VD decreases. The frame rate determining part 220 outputs the frame rate FR to the signal generator 240.

The signal generator 240 receives the frame rate FR from the frame rate determining part 220. The signal generator 240 receives the input image data RGB and the input control signal CONT from the external device (not shown). The signal generator 240 generates the data signal DATA based on the frame rate FR, the input image data RGB and the input control signal CONT, and outputs the data signal DATA to the data driver 500.

The signal generator 240 may output the data signal DATA by deleting some frames, when the frame rate FR is smaller then a normal frame rate of the display panel 100. For example, the signal generator 240 may output the data signal DATA by deleting the second frame F2, as illustrated in FIG. 3A.

The signal generator 240 may output the data signal DATA by deleting even-numbered frames. The signal generator 240 may output the data signal DATA by deleting odd-numbered frames. The signal generator 240 may output the data signal DATA by deleting 3n-th frames, where n is a natural number. The signal generator 240 may output the data signal DATA by deleting 4n-th frames.

FIG. 3B is a timing diagram illustrating the data signal DATA and the gate signals when the frame rate FR in FIG. 2 is the normal frame rate. FIG. 3C is a timing diagram illustrating the data signal DATA and the gate signals when the frame rate FR in FIG. 2 is decreased from the normal frame rate.

Referring to FIGS. 1, 2, 3A, 3B, and 3C, the distance measuring part 600 measures the distance VD between the viewer and the display apparatus. The distance measuring part 600 outputs the distance VD to the frame rate determining part 220.

The frame rate determining part 220 may adjust the frame rate FR of the image displayed on the display panel 100 based on the distance VD. The frame rate determining part 220 may decrease the frame rate FR, as the distance VD increases. The frame rate determining part 220 may increase the frame rate FR, as the distance VD decreases. The frame rate determining part 220 outputs the frame rate FR to the signal generator 240.

The signal generator 240 receives the frame rate FR from the frame rate determining part 220. The signal generator 240 receives the input image data RGB and the input control signal CONT from the external device (not shown). The signal generator 240 outputs the first control signal CONT1 to the gate driver 300 based on the input control signal CONT and the frame rate FR.

The gate driver 300 receives the first control signal CONT1 from the signal generator 240. The gate driver 300 generates the gate signals GS1, GS2, . . . , GSn based on the first control signal CONT1. A length of a first period, during which the gate signals GS1, GS2, . . . , GSn are activated, is T when the frame rate FR is normal. A length of a second period, during which the gate signals GS1, GS2, . . . , GSn are activated, is T′ when the frame rate FR is smaller than the normal frame rate. T′ may be longer than T. For example, T′ may be 2T. The gate driver 300 outputs the gate signals GS1, GS2, . . . , GSn to the display panel 100.

The signal generator 240 generates the second control signal CONT2 based on the input control signal CONT and the frame rate FR, and outputs the second control signal CONT2 to the data driver 500. The signal generator 240 generates the data signal DATA based on the frame rate FR, the input image data RGB, and the input control signal CONT, and outputs the data signal DATA to the data driver 500.

The data driver 500 receives the second control signal CONT2 and the data signal DATA. The data driver 500 outputs the data voltages to the data lines DL based on the second control signal CONT2 and the data signal DATA.

The display panel 100 includes the plurality of gate lines GL, the plurality of data lines DL, and the plurality of pixels connected to the gate lines GL and the data lines DL. The data voltages are charged to the pixels during the gate signals GS1, GS2, . . . , GSn are activated.

For example, the data voltages are charged to the pixels during the period of T, when the frame rate FR is normal. The data voltages are charged to the pixels during the period of T′, which is longer than the period of T, when the frame rate FR is smaller than the normal frame rate.

FIGS. 4A, 4B, 4C, and 4D are diagrams illustrating an exemplary operation of the timing controller of FIG. 2 when the frame rate increases, based on the data signal DATA. Referring to FIGS. 1, 2, 4A, 4B, 4C, and 4D, the distance measuring part 600 measures the distance VD between the viewer and the display apparatus. The distance measuring part 600 outputs the distance VD to the frame rate determining part 220.

The frame rate determining part 220 may adjust the frame rate FR of the image displayed on the display panel 100 based on the distance VD. The frame rate determining part 220 may decrease the frame rate FR, as the distance VD increases. The frame rate determining part 220 may increase the frame rate FR, as the distance VD decreases. The frame rate determining part 220 outputs the frame rate FR to the signal generator 240.

The signal generator 240 receives the frame rate FR from the frame rate determining part 220. The signal generator 240 receives the input image data RGB and the input control signal CONT from the external device (not shown). The signal generator 240 generates the data signal DATA based on the frame rate FR, the input image data RGB and the input control signal CONT, and outputs the data signal DATA to the data driver 500.

A compensation frame CF may be added between the first frame F1 and the second frame F2, when the frame rate FR is greater than the normal frame rate of the display panel 100.

Referring to FIG. 4B, the compensation frame CF may be a first compensation frame CFa having substantially the same data as one of data of the first frame F1 and data of the second frame F2.

Referring to FIG. 4C, the compensation frame CF may be a second compensation frame CFb generated by a Motion Estimation Motion Compensation (MEMC) scheme. According to the MEMC scheme, the compensation frame CF may be the second compensation frame CFb generated by predicting a movement from the first frame F1 to the second frame F2 based on the data of the first frame F1 and the data of the second frame F2 so that data of the second compensation frame CFb has a middle data between the data of the first frame F1 and the data of the second frame F2.

In exemplary embodiments, a plurality of compensation frames CF may be added between the first frame F1 and the second frame F2, when the frame rate FR is greater than the normal frame rate of the display panel 100. In such case, each of the plurality of compensation frames CF may be at least one of the first compensation frame CFa and the second compensation frame CFb.

In exemplary embodiments, the compensation frame CF may be added between a 2n-th (n is a natural number) frame and a (2n+1)-th frame, when the frame rate FR is greater than the fundamental frame rate of the display panel 100. The compensation frame CF may also be added between a 3n-th frame and a (3n+1)-th frame, when the frame rate FR is greater than the fundamental frame rate of the display panel 100.

According to exemplary embodiments, as the distance between the viewer and the display apparatus increases, a charging period of the pixels may be increased and a power consumption can be reduced by decreasing the frame rate. As the distance decreases, a display quality can be improved by increasing the frame rate. In adding the compensation frame, a frame doubling scheme or the MEMC scheme can be used.

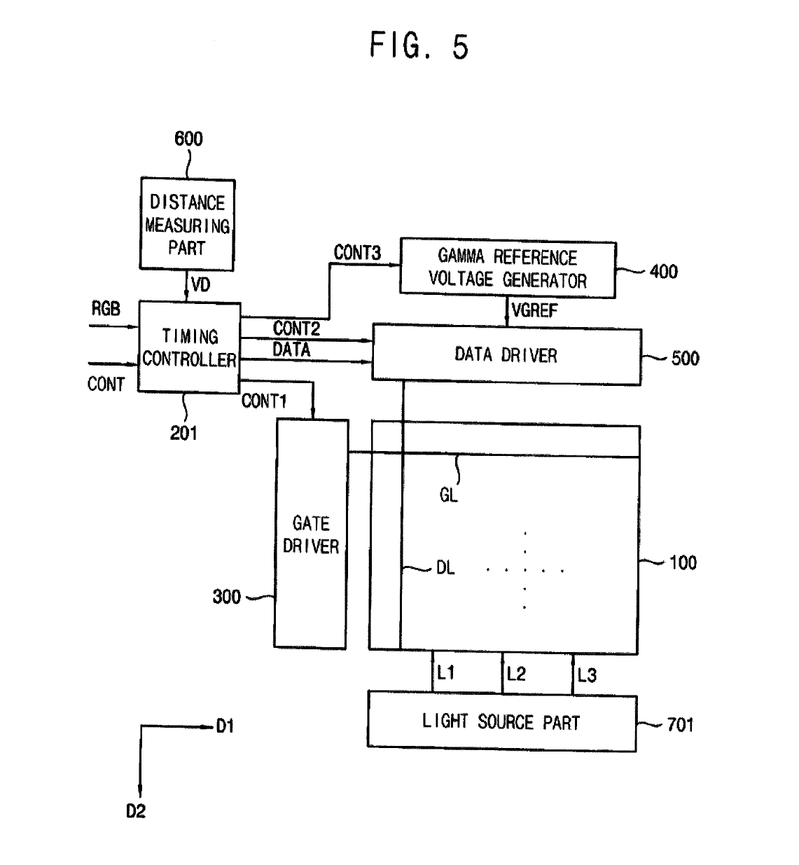

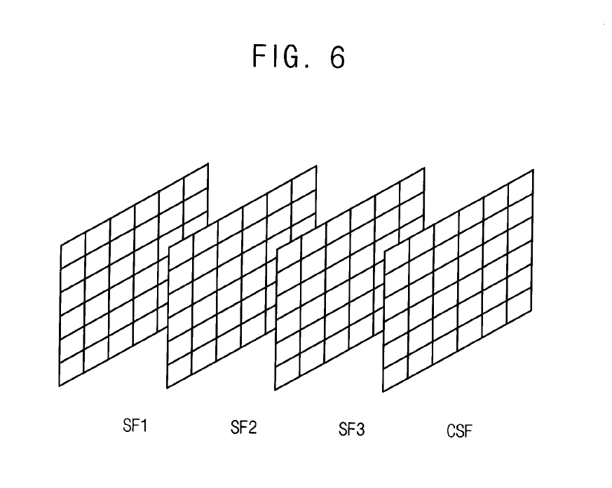

FIG. 5 is a block diagram illustrating a display apparatus according to exemplary embodiments. FIG. 6 is a diagram illustrating an image when a frame rate increases in FIG. 5.

Hereinafter, any repetitive explanation concerning the above elements will be omitted.

Referring to FIGS. 5 and 6, a timing controller 201 receives a distance VD between a viewer and the display apparatus from a distance measuring part 600. The timing controller 201 receives an input image data RGB and an input control signal CONT from an external device (not shown).

The timing controller 201 may adjust a frame rate FR of an image displayed on a display panel 100 based on the distance VD. The timing controller 201 is configured to output a light control signal CONT4 to a light source part 701 based on the frame rate FR and the input control signal CONT. The light control signal CONT4 may control operations of the light source part 701 based on the frame rate FR.

The image includes a first frame. The first frame includes a first sub-frame SF1, a second sub-frame SF2 and a third sub-frame SF3.

The light source part 701 includes a first light source L1, a second light source L2 and a third light source L3. The light source part 701 turns on the first light source L1 during the first sub-frame SF1. The light source part 701 turns on the second light source L2 during the second sub-frame SF2. The light source part 701 turns on the third light source L3 during the third sub-frame SF3.

The timing controller 201 may decrease the frame rate FR, as the distance VD increases. The timing controller 201 may increase the frame rate FR, as the distance VD decreases.

A compensation sub-frame CSF may be further added in the first frame, when the frame rate FR is greater than a fundamental frame rate of the display panel 100.

For example, the compensation sub-frame CSF may be added between the first sub-frame SF1 and the second sub-frame SF2. The compensation sub-frame CSF may be added between the second sub-frame SF2 and the third sub-frame SF3. The compensation sub-frame CSF may also be added right after the third sub-frame SF3.

The light source part 701 may turn on at least one of the first light source L1, the second light source L2, and the third light source L3 during the compensation sub-frame CSF.

The light source part 701 may turn on the first light source L1 and the second light source L2 during the compensation sub-frame CSF. The light source part 701 may turn on the second light source L2 and the third light source L3 during the compensation sub-frame CSF. The light source part 701 may also turn on the first light source L1 and the third light source L3 during the compensation sub-frame CSF.

The plurality of compensation sub-frames CSF may be added in the first frame, when the frame rate FR is greater than the fundamental frame rate of the display panel 100.

The light source part 701 may turn on the first light source L1, the second light source L2, and the third light source L3 during all of the plurality of compensation sub-frame CSF. The light source part 701 may turn on the first light source L1 and the second light source L2 during all of the plurality of compensation sub-frame CSF.

The light source part 701 may turn on the first light source L1, the second light source L2, and the third light source L3 during a first compensation sub-frame of the plurality of compensation sub-frame CSF. In this case, the light source part 701 may turn on the first light source L1 and the second light source L2 during a second compensation sub-frame of the plurality of compensation sub-frame CSF.

The first light source L1, the second light source L2, and the third light source L3 may be respectively one of a red color, a green color, and a blue color. For example, the first light source L1 may be the red color. The second light source L2 may be the green color. The third light source L3 may be the blue color.

According to exemplary embodiments, the frame rate can be adjusted based on the distance between the viewer and the display apparatus during a field sequential driving, and the color of the light source turned on in the compensation sub-frame can be chosen variously.

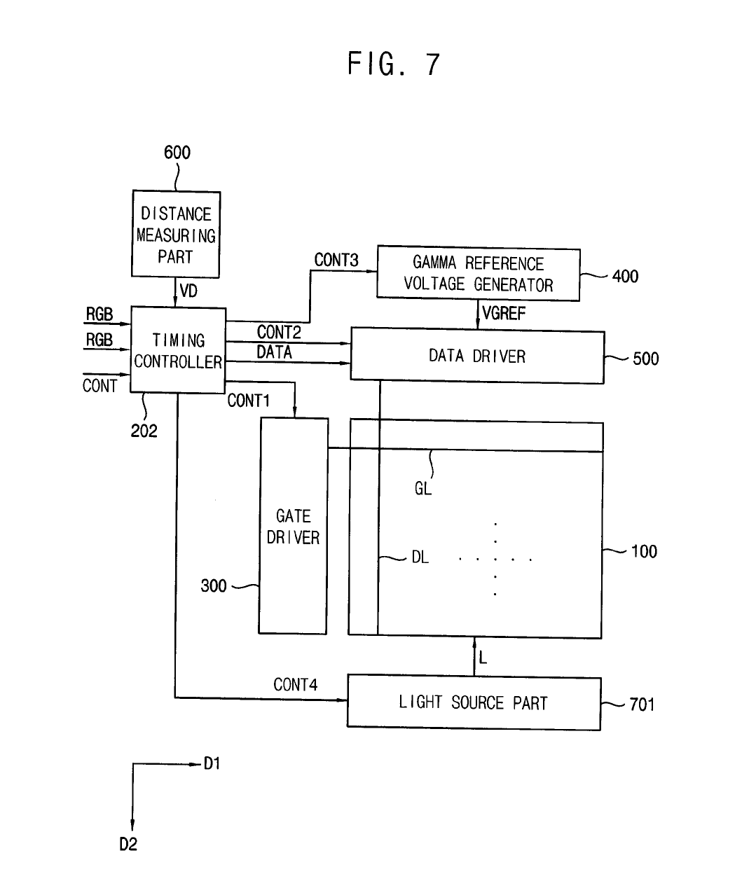

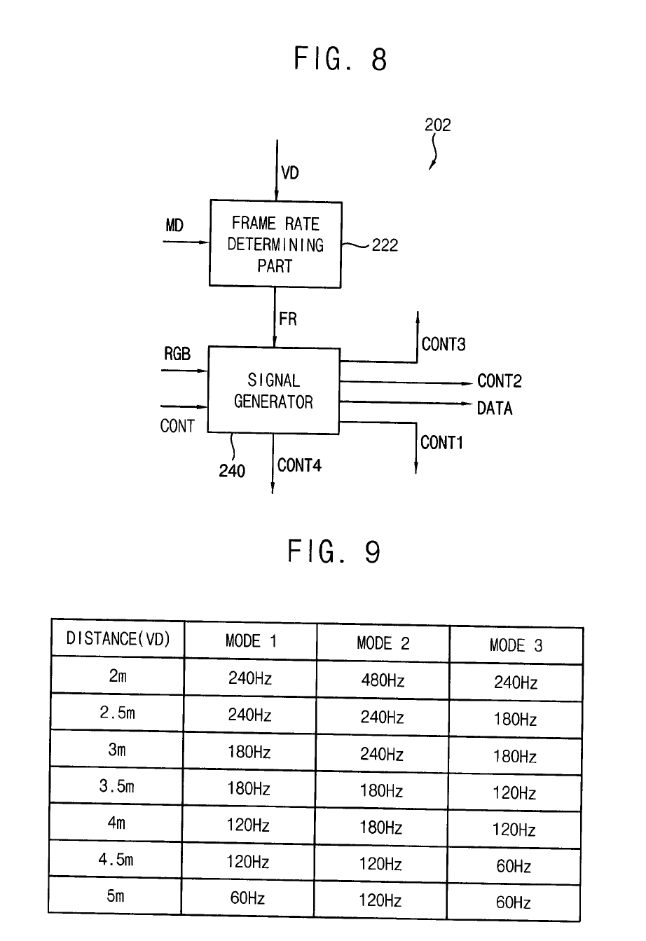

FIG. 7 is a block diagram illustrating a display apparatus according to exemplary embodiments. FIG. 8 is a block diagram illustrating an exemplary embodiment of a timing controller illustrated in FIG. 7. Hereinafter, any repetitive explanation concerning the above elements will be omitted.

Referring to FIGS. 7 and 8, a viewer can set an operation mode MD. A timing controller 202 includes a frame rate determining part 222 and the signal generator 240.

The frame rate determining part 222 receives a distance VD between the viewer and the display apparatus from a distance measuring part 600. The frame rate determining part 222 receives the mode MD set by the viewer. The frame rate determining part 222 may adjust a frame rate of an image display on a display panel 100 based on the distance VD and the mode MD. The frame rate determining part 222 may decrease the frame rate FR, as the distance VD increases. The frame rate determining part 222 may increase the frame rate FR, as the distance VD decreases. The frame rate determining part 222 may change an operation mode of the display apparatus for adjusting the frame rate FR based on the mode MD.

The frame rate determining part 222 may adjust the frame rate FR based on a look-up table. The frame rate determining part 222 may also adjust the frame rate FR based on a functional formula.

According to exemplary embodiments, the frame rate may be adjusted according to a viewing characteristic of each viewer.

FIG. 9 is an exemplary look-up table stored in a frame rate determining part illustrated in FIG. 8.

Referring to FIGS. 7, 8, and 9, the frame rate determining part 222 may adjust the frame rate FR of the image display on the display panel 100 based on the distance VD between the viewer and the display apparatus and the mode MD set by the viewer by using the look-up table.

For example, the distance VD may be an approximate value of a real measured distance. The operation mode of the display apparatus for adjusting the frame rate FR may be changed based on the mode MD under substantially same distance. The frame rate determining part 222 may also adjust the frame rate FR by using the functional formula of the distance VD and the mode MD.

According to the exemplary embodiments of the present inventive concept as explained above, by adjusting the frame rate of the image based on the distance between the viewer and the display apparatus, the power consumption of the display apparatus can be reduced when the distance is long, and the display quality may be improved when the distance is short.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims.

What is claimed is:

1. A method of driving a display apparatus, the method comprising:
measuring a distance between a viewer and the display apparatus; and
adjusting a frame rate of an image displayed on a display panel based on the distance,
wherein the display apparatus comprises the display panel.

2. The method of claim 1, wherein the frame rate is decreased in response to an increase in the distance.

3. The method of claim 2, wherein adjusting the frame rate further comprises:
increasing a charging period of a pixel in response to an increase in the distance,
wherein the display panel comprises the pixel.

4. The method of claim 3, further comprising:
decreasing a brightness of a light source in response to an increase in the distance,
wherein the display apparatus further comprises the light source.

5. The method of claim 1, wherein adjusting the frame rate comprises:
increasing the frame rate in response to a decrease in the distance.

6. The method of claim 5, wherein adjusting the frame rate further comprises:
adding a compensation frame between a first frame and a second frame in response to an increase in the frame rate,
wherein the image comprises the first frame and the second frame, and
wherein the compensation frame comprises substantially similar data as data of the first frame or data of the second frame.

7. The method of claim 5, wherein adjusting the frame rate further comprises:
adding a compensation frame between a first frame and a second frame in response to an increase in the frame rate,
wherein the image comprises the first frame and the second frame, and
wherein the compensation frame is generated by a Motion Estimation Motion Compensation (MEMC) scheme.

8. The method of claim 5, wherein adjusting the frame rate further comprises:
adding a first compensation frame and a second compensation frame between a first frame and a second frame in response to an increase in the frame rate,
wherein the image comprises the first frame and the second frame,
wherein the first compensation frame comprises substantially similar data as data of the first frame or data of the second frame, and
wherein the second compensation frame is generated according to a Motion Estimation Motion Compensation (MEMC) scheme.

9. The method of claim 5, further comprising:
turning on a first light source during a first sub-frame;
turning on a second light source during a second sub-frame; and
turning on a third light source during a third sub-frame,
wherein adjusting the frame rate further comprises:
adding a compensation sub-frame in a first frame in response to an increase in the frame rat; and
turning on the first light source, the second light source, and the third light source during the compensation sub-frame,
wherein the display apparatus comprises a light source part comprising the first light source, the second light source, and the third light source, and
wherein the image comprises the first frame comprising the first sub-frame, the second sub-frame, and the third sub-frame.

10. The method of claim 5, further comprising:
turning on a first light source during a first sub-frame;
turning on a second light source during a second sub-frame; and
turning on a third light source is turned on during a third sub-frame,
wherein adjusting the frame rate further comprises:
adding a compensation sub-frame in the first frame in response to an increase in the frame rate; and
turning on the first light source and the second light source during the compensation sub-frame,
wherein the display apparatus comprises a light source part comprising the first light source, the second light source, and the third light source, and
wherein the image comprises the first frame comprising the first sub-frame, the second sub-frame, and the third sub-frame.

11. The method of claim 1, further comprising:
receiving a viewer-selected operation mode of the display apparatus,
wherein the frame rate is adjusted based on the viewer-selected operation mode.

12. The method of claim 1, wherein the frame rate is adjusted based on a look-up table.

13. A display apparatus comprising:
a display panel configured to display an image;
a distance measuring component configured to measure a distance between a viewer and the display apparatus;
a timing controller configured to:
adjust a frame rate of the image based on the distance; and
generate a first control signal, a second control signal, and a data signal based on the frame rate;
a gate driver configured to output a gate signal based on the first control signal; and
a data driver configured to output a data voltage based on the second control signal and the data signal.

14. The display apparatus of claim 13, wherein the timing controller comprises:
a frame rate determining component configured to adjust the frame rate of the image based on the distance; and
a signal generator configured to generate the first control signal, the second control signal and, the data signal based on the frame rate.

15. The display apparatus of claim 14, wherein the frame rate determining component is configured to decrease the frame rate in response to an increase in the distance.

16. The display apparatus of claim 14, wherein the frame rate determining component is configured to increase the frame rate in response to a decrease in the distance.

17. The display apparatus of claim 16, wherein:
the image comprises a first frame and a second frame;
the signal generator is configured to generate the data signal via addition of a compensation frame between the first frame and the second frame in response to an increase in the frame rate; and
the compensation frame comprises substantially similar data as data of the first frame or data of the second frame.

18. The display apparatus of claim 16, wherein:
the image comprises a first frame and a second frame;
the signal generator is configured to, in response to an increase in the frame rate, generate the data signal via addition of a compensation frame between the first frame and the second frame; and
the compensation frame is generated according to a Motion Estimation Motion Compensation (MEMC) scheme.

19. The display apparatus of claim 16, further comprising:
a light source part comprising:
a first light source turned on during a first sub-frame;
a second light source turned on during a second sub-frame; and
a third light source turned on during a third sub-frame,
wherein the signal generator is configured to generate the data signal by adding a compensation sub-frame when the frame rate increases, and
wherein the light source is configured to turn on the first light source, the second light source, and the third light source during the compensation sub-frame.
